(19) United States
(12) Patent Application Publication
(10) Pub. No.: US 2010/0055341 A1
(43) Pub. Date: Mar. 4, 2010

(54) CARBON NANOTUBE NETWORKS WITH CONDUCTIVE POLYMER

(75) Inventors: Yong Hyup Kim, Seoul (KR); Tae June Kang, Seoul (KR)

Correspondence Address: KNOBBE MARTENS OLSON & BEAR LLP, 2040 MAIN STREET, FOURTEENTH FLOOR, IRVINE, CA, 92614, US

(73) Assignee: SEOUL NATIONAL UNIVERSITY RESEARCH & DEVELOPMENT BUSINESS FOUNDATION (SNU R&DB FOUNDATION), Seoul (KR)

(21) Appl. No.: 12/198,799

(22) Filed: Aug. 26, 2008

(51) Int. Cl. B05D 3/14

(52) U.S. Cl. 427/532; 977/742

(57) ABSTRACT

Techniques for making structures comprising a carbon nanotube (CNT) network and conductive polymer are provided. The conductive polymer may be in the form of a solid structure that may be thermally degraded and cooled.

### TECHNICAL FIELD

The present disclosure relates generally to carbon nanotubes and, more particularly, to carbon nanotube networks with conductive polymers.

### BACKGROUND

Carbon nanotubes (CNTs) may be utilized in numerous applications due to their physical properties. However, it may be difficult to reproduce single CNT devices consistently because of the variation in the chirality and geometry of the CNTs.

### SUMMARY

Techniques for making a carbon nanotube network are provided. In one embodiment, by way of non-limiting example, a method may include providing a conductive polymer to a network of two or more carbon nanotubes, wherein the conductive polymer is in the form of solid particles; thermally degrading the conductive polymer by applying an electric current to the network of two or more carbon nanotubes; and cooling the conductive polymer to be associated with the network of two or more carbon nanotubes.

Techniques for making a transparent conducting electrode are also provided. In one embodiment, by way of non-limiting example, one or more methods may involve forming a network of two or more carbon nanotubes on a substrate; providing a conductive polymer to the network of two or more carbon nanotubes, with the conductive polymer in the form of a solid particle; thermally degrading the conductive polymer by applying an electric current to the network of two or more carbon nanotubes; and cooling the conductive polymer to be associated with the network of two or more carbon nanotubes.

The Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a schematic diagram of an illustrative embodiment of a carbon nanotube (CNT) network with conductive polymer; and

FIGS. 2A-C are schematic diagrams of an illustrative embodiment of a method for making a CNT network.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the components of the present disclosure may be arranged and designed in a wide variety of different configurations. Those of ordinary skill will appreciate, in light of the present disclosure, that the functions performed in the methods may be implemented in differing order, and that the outlined steps are provided only as examples, and some of the steps may be optional, combined into fewer steps, or expanded to include additional steps while still being encompassed within the scope of the claims.

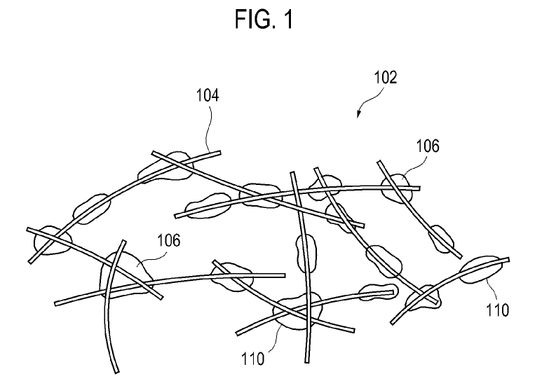

FIG. 1 is a schematic diagram of an illustrative embodiment of a carbon nanotube (CNT) network 102 with a conductive polymer 110. As used herein, the term “network” may refer to a plurality of CNTs 104 that may be substantially connected together. In some embodiments, the CNT network 102 may include a conductive polymer 110 that may be associated with the CNTs 104. The conductive polymer 110 may be attached to the CNTs 104 through thermal degrading and cooling. The conductive polymer 110 may be randomly dispersed throughout the CNT network 102. The conductive polymer 110 present at the intertube junctions 106 among two or more CNTs 104 may provide one or more bridges among the CNTs 104. As used herein, the term “bridges” may refer to a material connecting the CNTs 104. In some embodiments, some of the conductive polymer 110 may connect the CNTs 104.

The conductive polymer 110 may associate, bridge, or connect the CNTs 104 at the intertube junctions 106, and may reduce the resistance of the intertube junctions 106. As a result, the overall conductivity of the CNT network 102 may be increased. Additionally, the conductive polymer 110 may reduce the transparency of the CNT network 102.

In some embodiments, the size and/or amount of the conductive polymer 110 associated with the CNT network 102 may be selected such that the transparency of the CNT network 102 is not substantially reduced. After the association of conductive polymer 110 with the CNT network 102, the transparency within the range of visible light (380-780 nm) may be reduced by about 10% or less, or by about 5% or less. The transparency may be determined by measuring transmittance using an ultra violet-visible-near infrared (UV-VIS-NIR) spectrophotometer. Although the conductivity of the CNT network 102 may improve as the size of the conductive polymer 110 increases, the transparency of the CNT network 102 may diminish as the size and/or amount of the conductive polymer 110 increases.

In some embodiments, the size of the conductive polymer 110 associated with the CNTs 104 may fall between a variety of ranges. Thus, the conductive polymer 110 associated with the CNTs 104 may range from about 1 nm to about 10 μm, from about 10 nm to about 10 μm, from about 100 nm to about 10 μm, from about 1 μm to about 10 μm, from about 1 nm to about 10 nm, from about 1 nm to about 100 nm, from 1 nm to about 1 μm, from about 10 nm to about 100 nm, or from about 100 nm to about 1 μm. In other embodiments, size of the conductive polymer 110 associated with the CNTs 104 may be about 1 nm, about 10 nm, about 100 nm, about 1 μm, or about 10 μm.

Various types of conductive polymers 110 may be used. In some embodiments, suitable conductive polymers 110 may include, but are not limited to, polyaniline, polyimide, polyester, polyacetylene, polypyrrole, polythiophene, poly-p-phenylenevinylene, polyepoxide, polydimethylsiloxane, polyacrylate, polymethacrylate, polymethyl methacrylate, cellulose acetate, polystyrene, polycarbonate, polysulphone, polyethersulphone, or polyvinyl acetate.

The conductive polymer 110 associated with CNTs 104 may lower the sheet resistance of the CNT network 102. The sheet resistance may fall within various ranges. For example, the CNT network 102 may have a sheet resistance of from about 10 Ω/sq to about 500 Ω/sq. In some embodiments, the sheet resistance of the CNT network 102 may range from about 50 Ω/sq to about 500 Ω/sq, from about 100 Ω/sq to about 500 Ω/sq, from about 200 Ω/sq to about 500 Ω/sq, from about 300 Ω/sq to about 500 Ω/sq, from about 400 Ω/sq to about 500 Ω/sq, from about 10 Ω/sq to about 50 Ω/sq, from about 10 Ω/sq to about 100 Ω/sq, from about 10 Ω/sq to about 200 Ω/sq, from about 10 Ω/sq to about 300 Ω/sq, from about 10 Ω/sq to about 400 Ω/sq, from about 50 Ω/sq to about 100 Ω/sq, from about 100 Ω/sq to about 200 Ω/sq, from about 200 Ω/sq to about 300 Ω/sq, or from about 300 Ω/sq to about 400 Ω/sq. In other embodiments, the sheet resistance of the CNT network 102 may be about 10 Ω/sq, about 50 Ω/sq, about 100 Ω/sq, about 200 Ω/sq, about 300 Ω/sq, 400 Ω/sq, or about 500 Ω/sq.

In one aspect, the CNT network 102 described above may be used as transparent conducting electrodes. The transparent conducting electrode may have different transmittance. In general, transparent conducting electrodes may have a transmittance of at least about 80%, at least about 85%, at least about 90%, or at least about 95%, within the range of visible light (380-780 nm). Transmittance may be measured by using a UV-VIS-NIR spectrophotometer. The transparent conducting electrodes including the CNT network 102 may have a transmittance of at least about 80%, about 85%, about 90%, about 95%, or at least about 99%, within the range of visible light.

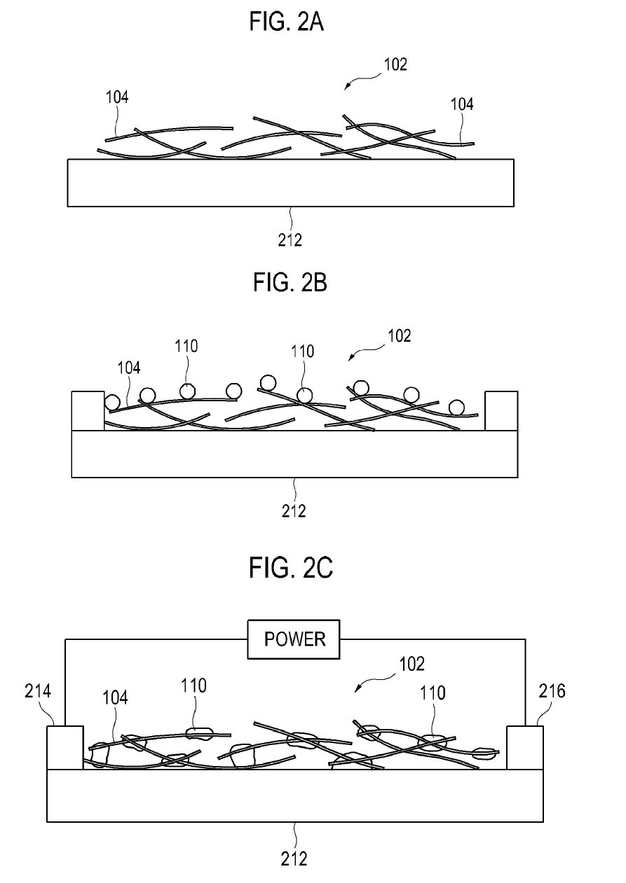

In another aspect, the present disclosure provides methods for making a CNT network 102. FIGS. 2A-C are schematic diagrams of an illustrative embodiment of a method for making a CNT network 102. In certain embodiments, the method may involve providing conductive polymer 110 to a network of two or more CNTs 104, wherein the conductive polymer 110 may be in the form of a solid particle; thermally degrading the conductive polymer 110 by applying an electric current to the network of two or more CNTs 104; and cooling the conductive polymer 110 to be associated with the network of two or more CNTs 104.

In some embodiments, the CNT network 102 may be prepared by using various techniques, such as, but not limited to, dip-coating, spin coating, bar coating, spraying, self-assembly, Langmuir- Blodgett deposition, vacuum filtration, or the like.

In one embodiment, a dip-coating method may be used to prepare the CNT network 102, and a CNT colloidal solution may be prepared by dispersing purified CNTs 104 in a solvent, such as deionized water or an organic solvent, for example, 1,2-dichlorobenzene, dimethyl formamide, benzene, methanol, or the like. Since the CNTs 104 produced by the currently available methods may contain impurities, they may need to be purified before being dispersed into the solution. An example of a suitable purification method may include refluxing CNTs 104 in nitric acid (for example, about 2.5 M) and re-suspending the CNTs 104 in water with a surfactant (for example, sodium lauryl sulfate, sodium cholate, or the like) at pH 10, and filtering the CNTs 104, for example, using a cross-flow filtration system. The resulting purified CNT 104 suspension may be passed through a filter, such as, but not limited to, a polytetrafluoroethylene filter.

The purified CNTs 104 may be in a powder form that may be dispersed into the solvent. In certain embodiments, an ultrasonic wave or microwave treatment may be carried out to facilitate the dispersion of the purified CNTs 104 throughout the solvent. The dispersion may be carried out in the presence of a surfactant, for example. Various types of surfactants including, but not limited to, sodium dodecyl sulfate, sodium dodecylbenzenesulfonate, sodium dodecylsulfonate, sodium n-lauroylsarcosinate, sodium alkyl allyl sulfosuccinate, polystyrene sulfonate, dodecyltrimethylammonium bromide, cetyltrimethylammonium bromide, Brij, Tween, Triton X, or poly(vinylpyrrolidone) may be used. Using the disclosed methods, a well-dispersed and stable CNT 104 mixture may be prepared.

As depicted in FIG. 2A, the CNT network 102 may be formed on a substrate 212. Suitable substrates 212 may include, for example, glass, glass wafer, silicon wafer, quartz, aluminum oxide, or zirconium. In one embodiment, the surface of the substrate 212 may be treated for wettability. Since a post-wet-process may be required after forming the CNT network 102, a hydrophilic self assembled monolayer coating or a piranha (H₂SO₄:H₂O₂=4:1) treatment may be applied to increase the adhesion between the CNT network 102 and the substrate 212.

As depicted in FIG. 2B, the conductive polymer 110 may be provided in the form of solid particles. In some embodiments, the conductive polymer 110 may be in the form of solid particles and may be directly provided to the CNT network 102.

In other embodiments, the conductive polymer 110 may be provided in the form of conductive polymer dispersion. The conductive polymer 110 in the form of solid particle may be added to a solvent to form the conductive polymer dispersion. In some examples, the conductive polymer 110, may be substantially dispersed, but not dissolved, in the solvent. The solvent may be, for example, water or alcohol. The conductive polymer dispersion may be sprayed to the CNT network 102.

In the present disclosure, the conductive polymer 110 may be used in the form of solid particle or in the form of conductive polymer dispersion, and the cost for using conductive polymer 110 may be advantageous as compared to using a conductive polymer solution, which may require complex processing, several reagents, and high costs.

Various types of conductive polymers 110 including, but not limited to, polyaniline, polyimide, polyester, polyacetylene, polypyrrole, polythiophene, poly-p-phenylenevinylene, polyepoxide, polydimethylsiloxane, polyacrylate, polymethacrylate, polymethyl methacrylate, cellulose acetate, polystyrene, polycarbonate, polysulphone, polyethersulphone, and polyvinyl acetate, may be used.

Referring to FIG. 2C, the conductive polymer 110 may be thermally degraded by applying an electric current to the CNT network 102. In one embodiment, the electric current may be provided by electrodes 214, 216 that may be disposed on the CNT network 102. The electrodes 214, 216 may be deposited on the CNT network 102 using physical vapor deposition techniques, including but not limited to, sputtering, E-beam evaporation, thermal evaporation, laser molecular beam epitaxy, pulsed laser deposition, or the like. The electric current generated by a power supply may be provided between the electrodes 214, 216 such that the electric current flows from one end of the CNT network 102 to the other end. In one embodiment, the electric current may be applied under vacuum. The electric current applied to the CNT network 102 may increase the temperature of the CNT network 102.

The heat generated may cause thermal degradation of the conductive polymer 110. The conductive polymer 110 may turn to a semi-liquid state when heated above its thermal degradation temperature. Thus, the temperature of the CNT network 102 may be increased above the thermal degradation temperature of the conductive polymer 110. In one embodiment, polyaniline may be used as the conductive polymer 110 and the temperature may be increased to at least about 320° C.

The temperature of the CNT network 102 may be controlled by changing the voltage of the power supply. The voltage of the power supply may fall within various ranges. However, if the voltage of the power supply is too low, sufficient heat required to degrade the conductive polymer 110 may not be generated. On the other hand, if the voltage of the power supply is too high, the CNT network 102 may be damaged by the generated heat. In various embodiments, the voltage of the power supply may range from about 100 V to about 500 V, from about 200 V to about 500 V, from about 300 V to about 500 V, from about 400 V to about 500 V, from about 100 V to about 200 V, from about I00 V to about 300 V, from about 100 V to about 400 V, from about 200 V to about 300 V, or from about 300 V to about 400 V. In other embodiments, the voltage of the power supply may be about 100 V, about 200 V, about 300 V, about 400 V, or about 500 V.

The conductive polymer 110 may be cooled to room temperature. As the conductive polymer 110 cools, it may attach to the CNT network 102. The conductive polymer 110 associated with the CNT network 102 may enhance the mechanical properties of the CNT network 102.

In some embodiments, the time of applying the electric current may be varied depending, for example, on the amount and type of conductive polymer 110 applied to the CNT network 102.

The sheet resistance may fall within various ranges. In various embodiments, the CNT network 102 may have a sheet resistance from about 10 Ω/sq to about 500 Ω/sq, from about 50 Ω/sq to about 500 Ω/sq, from about 100 Ω/sq to about 500 Ω/sq, from about 200 Ω/sq to about 500 Ω/sq, from about 300 Ω/sq to about 500 Ω/sq, from about 400 Ω/sq to about 500 Ω/sq, from about 10 Ω/sq to about 50 Ω/sq, from about 10 Ω/sq to about 100 Ω/sq, from about 10 Ω/sq to about 200 Ω/sq, from about 10 Ω/sq to about 300 Ω/sq, from about 10 Ω/sq to about 400 Ω/sq, from about 50 Ω/sq to about 100 Ω/sq, from about 100 Ω/sq to about 200 Ω/sq, from about 200 Ω/sq to about 300 Ω/sq, or from about 300 Ω/sq to about 400 Ω/sq. In other embodiments, the sheet resistance of the CNT network 102 may be about 10 Ω/sq, about 50 Ω/sq, about 100 Ω/sq, about 200 Ω/sq, about 300 Ω/sq, 400 Ω/sq, or about 500 Ω/sq. The CNT networks 102 may be used as transparent conducting electrodes.

### Preparation of a CNT Network

As discussed, in some embodiments, a CNT network 102 may be formed on a substrate 212. What follows is an example embodiment of forming a CNT network 102 on a substrate 212. In one embodiment, a CNT colloidal solution may be prepared. Sonication may be conducted for about 30 minutes in nitric acid to purify the CNTs 104 (for example, product number: ASP-100F, Iljin Nanotech, Seoul, Korea). The CNTs 104 may be substantially neutralized using deionized water after wet-oxidization, and they may be passed through a vacuum filtration device. The substantially purified CNTs 104 may be dispersed in 1,2-dichlorobenzene. An ultrasonication treatment may be carried out for about 10 hours to disperse the CNTs 104 throughout the solvent, and a well dispersed and stable CNT colloidal solution may be provided.

Two metal electrodes consisting of Cr/Au may be assembled on two opposite ends of a silicon substrate. The substrate may be treated with a Piranha (H₂SO₄:H₂O₂=4:1) treatment that may substantially remove the impurities from the surface of the substrate and may modify the surface of the substrate 212 so that it has polarity, which may increase the adhesion between the CNTs 104 and the substrate 212. To form a CNT network 102 on the substrate 212, dip coating may be carried out by immersing a silicon substrate vertically into the CNT colloidal solution with a withdrawal velocity of 0.3 mm/min at room temperature.

Associating the Conductive Polymer with the CNT Network and Results Measurement

As discussed, in some embodiments, a CNT network 102 may be associated with a conductive polymer 110. What follows is an example embodiment of associating a CNT network 102 with a conductive polymer 110. Each of two opposite ends of an above-prepared CNT network 102 may be connected to the electrodes 214, 216 on the substrate 212. Polyaniline particles having average size of about 10 nm (for example, ORMECON™, available from Ormecon GmbH, Ammersbek, Germany) may be added to water to obtain polyaniline dispersion. The polyaniline dispersion may be sprayed to the CNT network 102.

An electric current may be applied to the CNT network 102 between the electrodes 214, 216. The voltage of power supply may be maintained at about 400 V for about 1 minute, and the polyaniline particles may be degraded. The CNT network 102 may be cooled to room temperature.

The electrical resistance of the resulting CNT network 102 may be measured using, for example, a 4-point probe (such as, for example, model: CMT-SR2000N, AIT, Yongin, Korea), and the transparency of the resulting CNT network 102 may be measured using, for example, an ultraviolet-visible spectrophotometer (such as, for example, model: Lambda-20, Perkin Elmer, Waltham, Mass.).

Those skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations while still encompassed by the claims.

The herein described subject matter sometimes illustrates different components contained within, or connected with, different other components. It is to be understood that such depicted architectures are merely illustrative, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A method for making a carbon nanotube network comprising:
forming a network of two or more carbon nanotubes on a substrate;
providing a conductive polymer to the network of two or more carbon nanotubes, wherein the conductive polymer is in the form of a solid particle;
thermally degrading the conductive polymer by applying an electric current to the network of two or more carbon nanotubes; and
cooling the conductive polymer.

2. The method of claim 1, wherein said forming the network of two or more carbon nanotubes comprises at least one of dip-coating, spin coating, spraying, or vacuum filtration.

3. The method of claim 1, wherein the substrate comprises at least one of glass, glass wafer, silicon wafer, quartz, aluminum oxide, or zirconium.

4. The method of claim 1, wherein the conductive polymer comprises at least one of polyaniline, polyimide, polyester, polyacetylene, polypyrrole, polythiophene, poly-p-phenylenevinylene, polyepoxide, polydimethylsiloxane, polyacrylate, polymethacrylate, polymethyl methacrylate, cellulose acetate, polystyrene, polycarbonate, polysulphone, polyethersulphone, or polyvinyl acetate.

5. The method of claim 1, wherein said providing the conductive polymer to the network of two or more carbon nanotubes comprises:
adding the conductive polymer in the form of a solid particle to a solvent;
obtaining a conductive polymer dispersion; and
spraying the conductive polymer dispersion on the network of two or more carbon nanotubes.

6. The method of claim 5, wherein the solvent comprises at least one of water or alcohol.

7. The method of claim 1, wherein the solid particle has a size in the range from about 1 nm to about 10 μm.

8. The method of claim 1, wherein said thermally degrading the conductive polymer comprises:
disposing a first electrode and a second electrode on the network of two or more carbon nanotubes prior to thermal degradation of the conductive polymer; and
providing an electric current generated by a power supply between the first electrode and the second electrode to flow an electric current from a first end of the carbon nanotube network to a second end of the carbon nanotube network.

9. The method of claim 1, wherein said thermally degrading the conductive polymer comprises thermally degrading the conductive polymer under vacuum.

10. The method of claim 1, wherein the carbon nanotube network has a sheet resistance of about 10 Ω/sq to about 500 Ω/sq.

11. A method for making a transparent conducting electrode comprising:
forming a network of two or more carbon nanotubes on a substrate;
providing a conductive polymer to the network of two or more carbon nanotubes, wherein the conductive polymer is in the form of a solid particle, and wherein the solid particle has a size of about 1 nm to about 10 μm;
thermally degrading the conductive polymer by applying an electrical current to the network of two or more carbon nanotubes; and
cooling the conductive polymer.

12. The method of claim 11, wherein said forming the network of two or more carbon nanotubes comprises at least one of dip-coating, spin coating, spraying, or vacuum filtration

13. The method of claim 11, wherein the substrate comprises at least one of glass, glass wafer, silicon wafer, quartz, aluminum oxide, or zirconium.

14. The method of claim 11, wherein the conductive polymer comprises at least one of polyaniline, polyimide, polyester, polyacetylene, polypyrrole, polythiophene, poly-p-phenylenevinylene, polyepoxide, polydimethylsiloxane, polyacrylate, polymethacrylate, polymethyl methacrylate, cellulose acetate, polystyrene, polycarbonate, polysulphone, polyethersulphone, or polyvinyl acetate.

15. The method of claim 11, wherein said providing the conductive polymer to the network of two or more carbon nanotubes comprises:
adding the conductive polymer in the form of the solid particle to a solvent;
obtaining a conductive polymer dispersion; and
spraying the conductive polymer dispersion on the network of two or more carbon nanotubes.

16. The method of claim 15, wherein the solvent comprises at least one of water or alcohol.

17. The method of claim 11, wherein said thermally degrading the conductive polymer comprises:
disposing a first electrode and a second electrode on the network of two or more carbon nanotubes prior to thermally degrading the conductive polymer; and
providing an electric current generated by a power supply between the first electrode and the second electrode to flow electrical current from a first end of the carbon nanotube network to a second end of the carbon nanotube network.

18. The method of claim 11, wherein said thermally degrading the conductive polymer comprises thermally degrading the conductive polymer under vacuum.

19. The method of claim 11, wherein the carbon nanotube network has a sheet resistance of about 10 Ω/sq to about 500 Ω/sq.
